(19) United States
(12) Patent Application Publication
(10) Pub. No.: US 2013/0066814 A1
(43) Pub. Date: Mar. 14, 2013

(54) System and Method for Automated Classification of Web pages and Domains

(71) Applicants: Volker Bosch, Nuremberg (DE); Yves Marie LeMaitre, Poissy (FR)

(72) Inventors: Volker Bosch, Nuremberg (DE); Yves Marie LeMaitre, Poissy (FR)

(21) Appl. No.: 13/230,562

(22) Filed: Sep. 12, 2011

(51) Int. Cl. G06F 15/18; G06F 17/30

(52) U.S. Cl. 706/12

(57) ABSTRACT

Representative sample pages from websites accessible to Internet users are manually selected and classified into pre-defined categories based on page content to create a training set as an input to a classifier. An automated analysis is performed to identify a list of catchwords comprising the most frequently referenced words, tags, and/or links from the classified samples in each category in the training set. A data mining tool generates unique sets of distinctive catchwords and/or distinctive combinations of catchwords that have a high probability of appearing only in a single one of the pre-defined content categories. The classifier utilizes the sets of distinctive catchwords/combinations to classify new pages into one or more of the pre-defined content categories.

### CROSS-REFERENCE TO RELATED APPLICATIONS

This application is related to U.S. patent applications respectively entitled “System and Method for Relating Internet Usage with Mobile Equipment”, “A Method for Segmenting Users of Mobile Internet”, and “Analyzing Internet Traffic by Extrapolating Socio-Demographic information from a Panel” each being filed concurrently herewith and owned by the assignee of the present invention, and the disclosure of which is incorporated by reference herein in its entirety.

### BACKGROUND

Communication networks provide services and features to users that are increasingly important and relied upon to meet the demand for connectivity to the world at large. Communication networks, whether voice or data, are designed in view of a multitude of variables that must be carefully weighed and balanced in order to provide reliable and cost effective offerings that are often essential to maintain customer satisfaction. Accordingly, being able to analyze network activities and manage information gained from the accurate measurement of network traffic characteristics is generally important to ensure successful network operations.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

Representative sample pages from websites accessible to Internet users are manually selected and classified into pre-defined categories based on page content to create a training set as an input to a classifier. An automated analysis is performed to identify a list of catchwords comprising the most frequently referenced words, tags, and/or links from the classified samples in each category in the training set. A data mining tool generates unique sets of distinctive catchwords and/or distinctive combinations of catchwords that have a high probability of appearing only in a single one of the pre-defined content categories. The classifier utilizes the sets of distinctive catchwords/combinations to classify new pages into one or more of the pre-defined content categories.

In various illustrative examples, a network intelligence solution (NIS) is arranged to tap a stream of IP (Internet Protocol) packets traversing a node in the network between mobile equipment employed by network users and one or more remote web servers. The NIS performs deep packet inspection to measure Internet usage so that the sample pages in the training set may be selected using the most frequently visited sites in each of the pre-defined content categories.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 shows an illustrative mobile communications network environment that facilitates access to resources by users of mobile equipment and with which the present system and method may be implemented;

FIG. 2 shows an illustrative web browsing session which utilizes a request-response communication protocol;

FIG. 3 shows an illustrative NIS that may be located in a mobile communications network or node thereof and which processes information from traffic flowing in the network to measure Internet usage;

FIG. 4 shows an illustrative deep packet inspection machine that may be utilized to perform measurements of Internet usage;

FIG. 5 shows an overview of aspects of the present system and method for automated web content classification;

FIG. 6 provides a graphical representation of boundaries of a catchword list having Y most referenced words from sample pages in a category;

FIG. 7 shows how catchwords lists may overlap so that membership in a catchword list is not unique;

FIG. 8 provides a graphical representation of boundaries of distinctive catchwords (and/or distinctive catchword combinations) within respective larger catchword lists;

FIG. 9 shows application of an illustrative classification engine that uses the distinctive catchwords/combinations to classify new pages into the pre-defined content categories;

FIG. 10 is a flowchart of an illustrative method for automated classifications or pages and/or domains;

FIG. 11 is a flowchart of an illustrative method in which Internet usage measurements are performed using a network intelligence solution; and

FIG. 12 shows an illustrative application of the present automated classification in a web portal environment.

Like reference numerals indicate like elements in the drawings. Unless otherwise indicated, elements are not drawn to scale.

### DETAILED DESCRIPTION

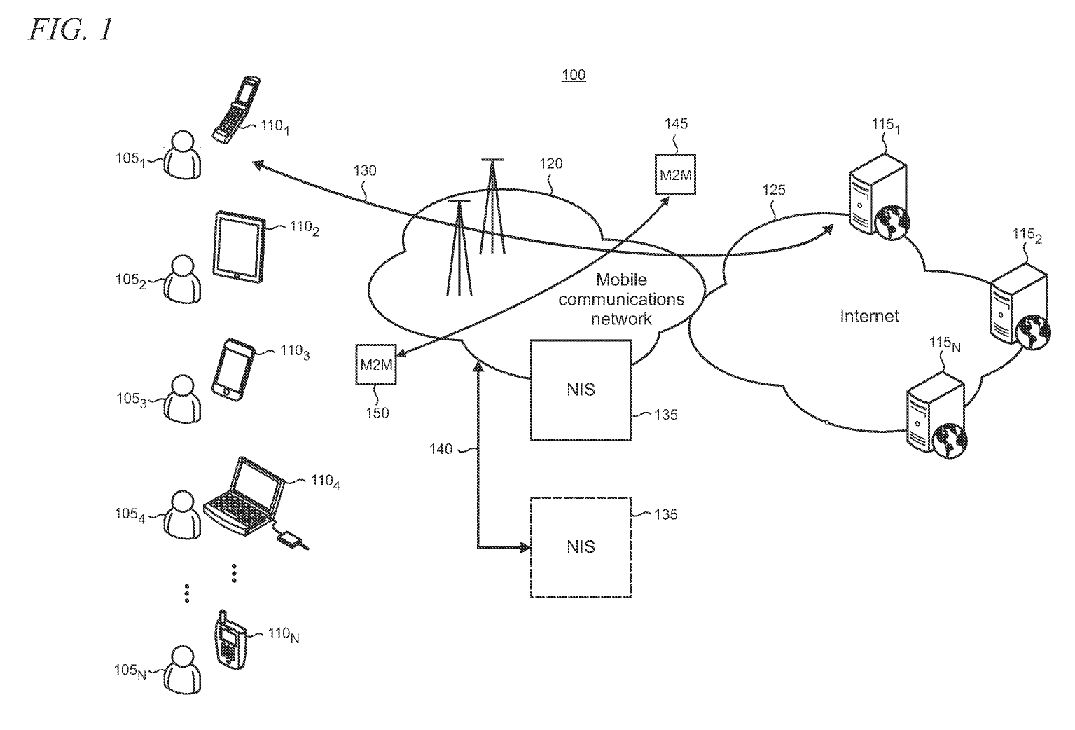

FIG. 1 shows an illustrative mobile communications network environment 100 that facilitates access to resources by users 105_{1, 2 . . . N} of mobile equipment 110_{1, 2 . . . N} and with which the present arrangement for automated classification may be implemented. In this example, the resources are web-based resources that are provided from various websites 115_{1, 2 . . . N}. Access is implemented, in this illustrative example, via a mobile communications network 120 that is operatively connected to the websites 115 via the Internet 125. It is emphasized that the present system and method are not necessarily limited in applicability to mobile communications network implementations and that other network types that facilitate access to the World Wide Web including local area and wide area networks, PSTNs (Public Switched Telephone Networks), and the like that may incorporate both wired and wireless infrastructure may be utilized in some implementations. In this illustrative example, the mobile communications network 120 may be arranged using one of a variety of alternative networking standards such as GPRS (General Packet Radio Service), UMTS (Universal Mobile Telecommunications System), GSM/EDGE (Global System for Mobile Communications/Enhanced Data rates for GSM Evolution), CDMA (Code Division Multiple Access), CDMA2000, or other 2.5G, 3G, 3G+, or 4G (2.5^{th} generation, 3^{rd} generation, 3^{rd} generation plus, and 4^{th} generation, respectively) wireless standards, and the like.

The mobile equipment 110 may include any of a variety of conventional electronic devices or information appliances that are typically portable and battery-operated and which may facilitate communications using voice and data. For example, the mobile equipment 110 can include mobile phones (e.g., non-smart phones having a minimum of 2.5G capability), e-mail appliances, smart phones, PDAs (personal digital assistants), ultra-mobile PCs (personal computers), tablet devices, tablet PCs, handheld game devices, digital media players, digital cameras including still and video cameras, GPS (global positioning system) navigation devices, pagers, electronic devices that are tethered or otherwise coupled to a network access device (e.g., wireless data card, dongle, modem, or other device having similar functionality to provide wireless Internet access to the electronic device) or devices which combine one or more of the features of such devices. Typically, the mobile equipment 110 will include various capabilities such as the provisioning of a user interface that enables a user 105 to access the Internet 125 and browse and selectively interact with web pages that are served by the Web servers 115, as representatively indicated by reference numeral 130.

The network environment 100 may also support communications among machine-to-machine (M2M) equipment and facilitate the utilization of various M2M applications. In this case, various instances of peer M2M equipment (representatively indicated by reference numerals 145 and 150) or other infrastructure supporting one or more M2M applications will send and receive traffic over the mobile communications network 120 and/or the Internet 125. In addition to accessing traffic on the mobile communications network 120 in order to classify web pages and domains in an automated manner, the present arrangement may also be adapted to access M2M traffic traversing the mobile communications network. Accordingly, while the methodology that follows is applicable to an illustrative example in which Internet usage of mobile equipment users is measured, those skilled in the art will appreciate that a similar methodology may be used when M2M equipment is utilized.

A NIS 135 is also provided in the environment 100 and operatively coupled to the mobile communications network 120, or to a network node thereof (not shown) in order to access traffic that flows through the network or node. In alternative implementations, the NIS 135 can be remotely located from the mobile communications network 120 and be operatively coupled to the network, or network node, using a communications link 140 over which a remote access protocol is implemented. In some instances of remote operation, a buffer (not shown) may be disposed in the mobile communications network 120 for locally buffering data that is accessed from the remotely located NIS.

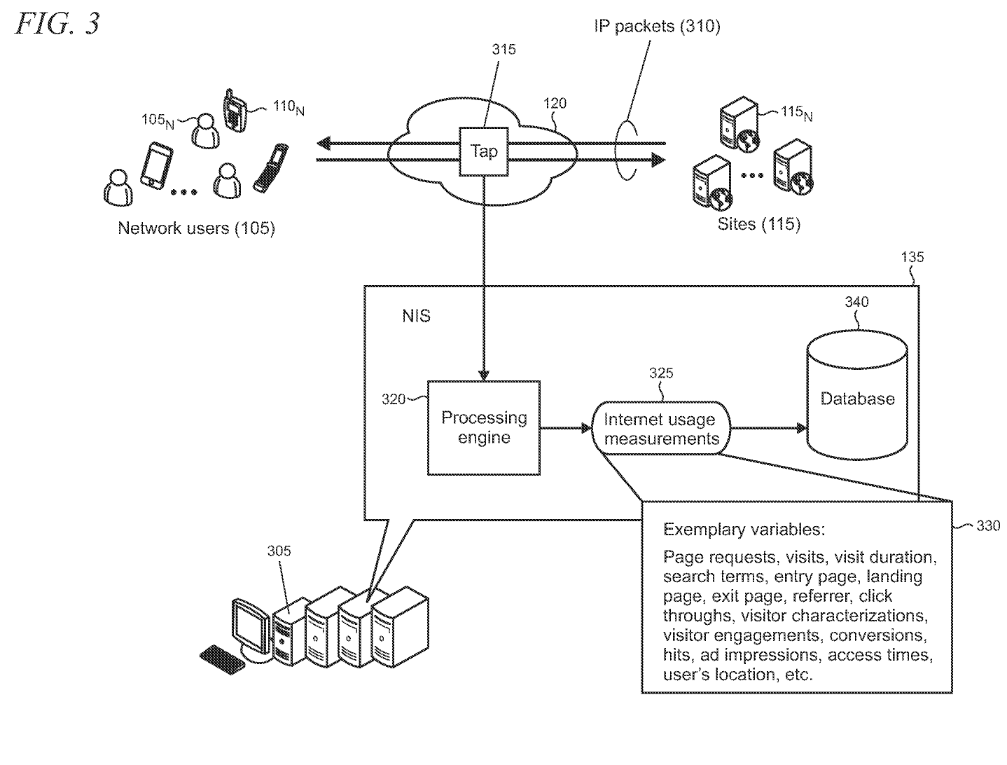

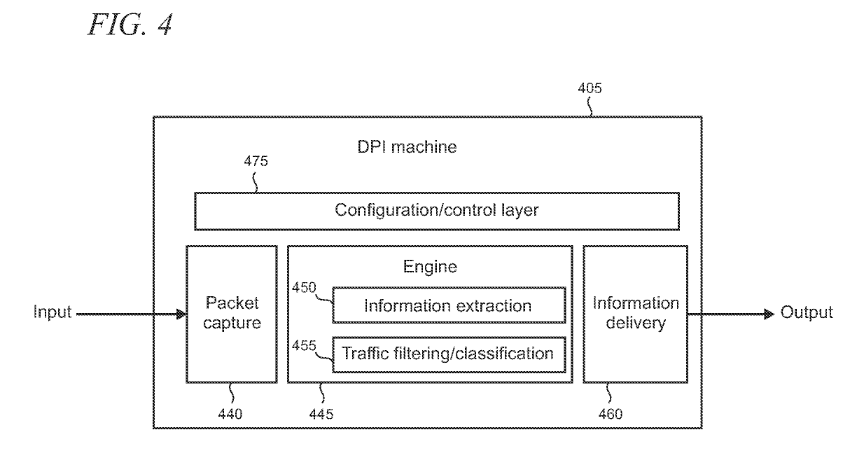

It is noted that performing network traffic analysis from a network-centric viewpoint can be particularly advantageous in many scenarios. For example, attempting to collect information at the mobile equipment 110 can be problematic because such devices are often configured to utilize thin client applications and typically feature streamlined capabilities such as reduced processing power, memory, and storage compared to other devices that are commonly used for web browsing such as PCs. In addition, collecting data at the network advantageously enables data to be aggregated across a number of instances of mobile equipment 110, and further reduces intrusiveness and the potential for violation of personal privacy that could result from the installation of monitoring software at the client. The NIS 135 is described in more detail in the text accompanying FIGS. 3 and 4 below.

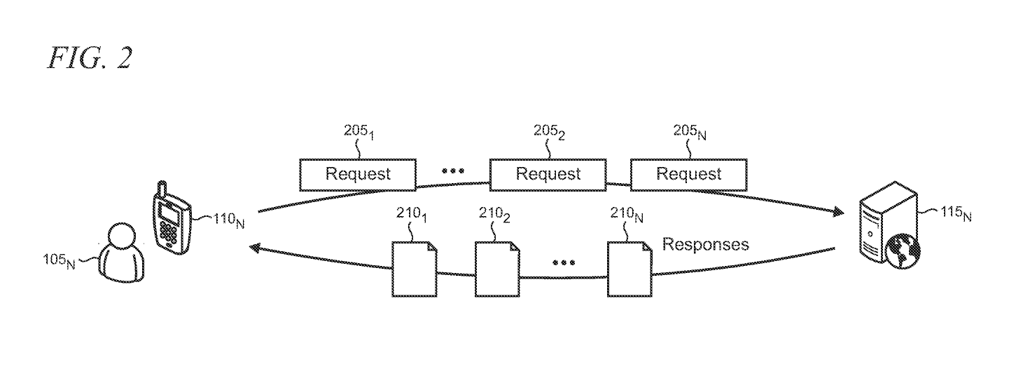

FIG. 2 shows an illustrative web browsing session which utilizes a protocol such as HTTP (HyperText Transfer Protocol) or SIP (Session Initiation Protocol). In this particular illustrative example, the web browsing session utilizes HTTP which is commonly referred to as a request-response protocol that is commonly utilized to access websites. Access typically consists of file requests 205_{1, 2 . . . N}for pages or objects from a browser application executing on the mobile equipment 110 to a website 115 and corresponding responses 210_{1, 2 . . . N} from the website server. Thus, at a high level, the user 105 interacts with a browser to request, for example, a URL (Uniform Resource Locator) to identify a site of interest, then the browser requests the page from the website 115. When receiving the page, the browser parses it to find all of the component objects such as images, sounds, scripts, etc., and then makes requests to download these objects from the website 115.

FIG. 3 shows details of the NIS 135 which is arranged, in this illustrative example, to collect and analyze network traffic through the mobile communications network 120 in order to make measurements of Internet usage by the users 105 of the network and mobile equipment 110. The NIS 135 is typically configured as one or more software applications or code sets that are operative on a computing platform such as a server 305 or distributed computing system. In alternative implementations, the NIS 135 can be arranged using hardware and/or firmware, or various combinations of hardware, firmware, or software as may be needed to meet the requirements of a particular usage scenario. As shown, network traffic typically in the form of IP packets 310 flowing through the mobile communications network 120, or a node of the network, is captured via a tap 315. A processing engine 320 takes the captured IP packets to make measurements of Internet usage 325 which can be typically written to one or more databases (representatively indicated by reference numeral 340) in common implementations.

As shown in FIG. 3, exemplary variables 330 that may be measured include page requests, visits, visit duration, search terms, entry page, landing page, exit page, referrer, click throughs, visitor characterizations, visitor engagements, conversions, hits, ad impressions, access times (time of day, day of week, etc.), the user's location (city, country, geo-location, etc.), and the like. It is emphasized that the exemplary variables shown in FIG. 3 are intended to be illustrative and that the number and particular variables that are utilized in any given application can differ from what is shown as required by the needs of a given application.

As shown in FIG. 4, the NIS 135 can be implemented, at least in part, using a deep packet inspection (“DPI”) machine 405. DPI machines are known and commercially available examples include the ixMachine produced by Qosmos SA. The IP packets 310 (FIG. 3) are collected in a packet capture component 440 of the DPI machine 405. An engine 445 takes the captured IP packets to extract various types of information, as indicated by reference numeral 450, and filter and/or classify the traffic, as indicated by reference numeral 455. An information delivery component 460 of the DPI machine 405 then outputs the data generated by the DPI engine 445. Software code may execute in a configuration and control layer 475 in the DPI machine 405 to control the DPI engine output and information delivery 460. In some implementations of the DPI machine 405, an API (application programming interface) (not shown in FIG. 4) can be specifically exposed to enable certain control of the DPI machine responsively to remote calls to the interface.

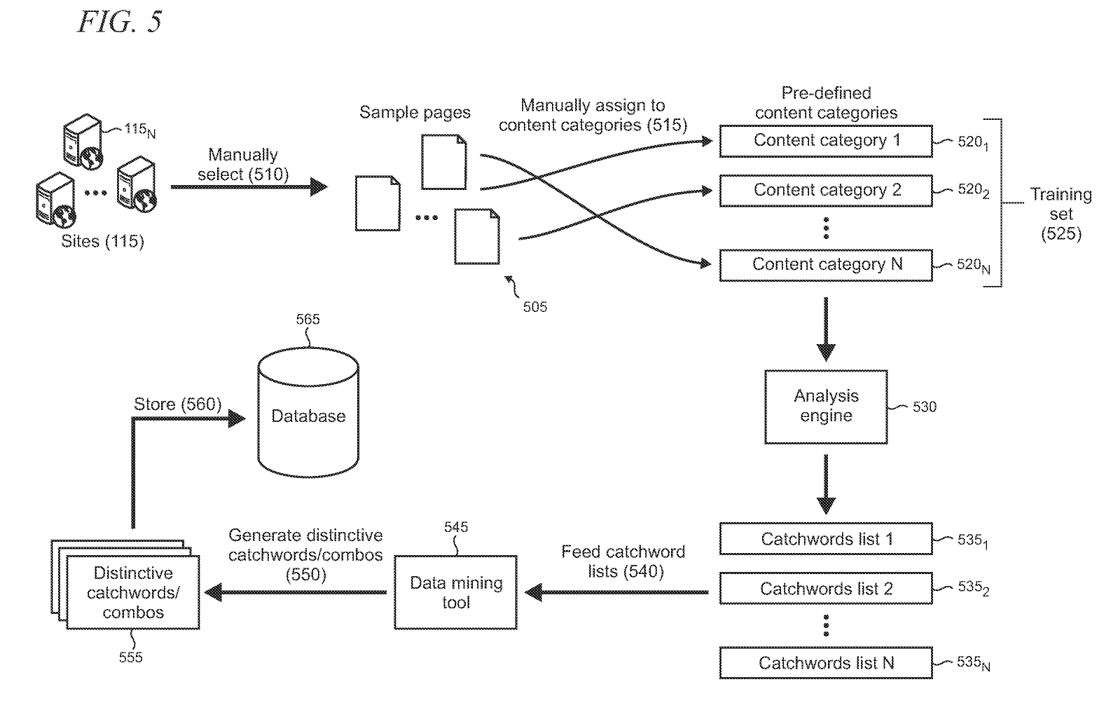

As shown in FIG. 5, in accordance with the present automated classification, a set of pages 505 are manually selected, as indicated by reference numeral 510, from the websites 115. It is emphasized that while pages are illustratively shown and described here, the present arrangement is also applicable to domains as well as to a combination of domains and pages. While the criteria used to manually select the pages 505 can vary by application, typically a representative sample of pages are selected which are the most frequently visited in each of a variety of content categories. The sample pages 505 are manually classified according to content, as indicated by reference numeral 515, into various pre-defined content categories 520_{1, 2 . . . N}. That is, pages that share some given degree of similarity with respect to content will be populated into the same category. The number and types of categories utilized, the categorization criteria utilized, and the number of pages 505 classified into each category may vary by application. Exemplary pre-defined content categories could include, for example, sports, finance, government, health, humanities, science and technology, companies, travel, computers, education, news and media, entertainment, movies and television, etc.

The classified pages in the pre-defined content categories constitute a training set 525 that functions as an input to an analysis process for generating a list of catchwords 535 for each of the categories which are typically stored in a database (not shown). The analysis is typically performed in an automated manner using, for example, an analysis engine 530 or other tool that may be implemented using software executing on a computing platform. Each list of catchwords 535 may be defined to include the Y most frequently referenced words, tags, and/or links appearing on a set of pages or domains in a given content category 520 where the variable Y (i.e., the reference frequency threshold) can be the same or different for each category. The lists of catchwords 535 are fed as an input, as indicated by reference numeral 540, to a data mining tool 545. The data mining tool 545 searches for relationships in the input data using any of a variety of data mining algorithms that are commonly statistically-based such as regression, classification, clustering, neural networks, k-nearest neighbors, and the like. Data mining tools may typically be implemented using software that executes on a computing platform, such as a server that may be located in the NIS 135 (FIG. 1) using input data from one or more databases.

The data mining tool 545 is configured to generate, as indicated by reference numeral 550, a unique set of distinctive catchwords and/or particular combinations of catchwords for each content category. Each set of generated distinctive catchwords/combinations 555 will typically have a high probability of appearing only within a single content category (where “high” is defined here as that which exceeds some acceptable probability threshold which can vary by application). The sets 555 of distinctive catchwords/combinations can be stored, as indicated by reference numeral 560 in a database 565.

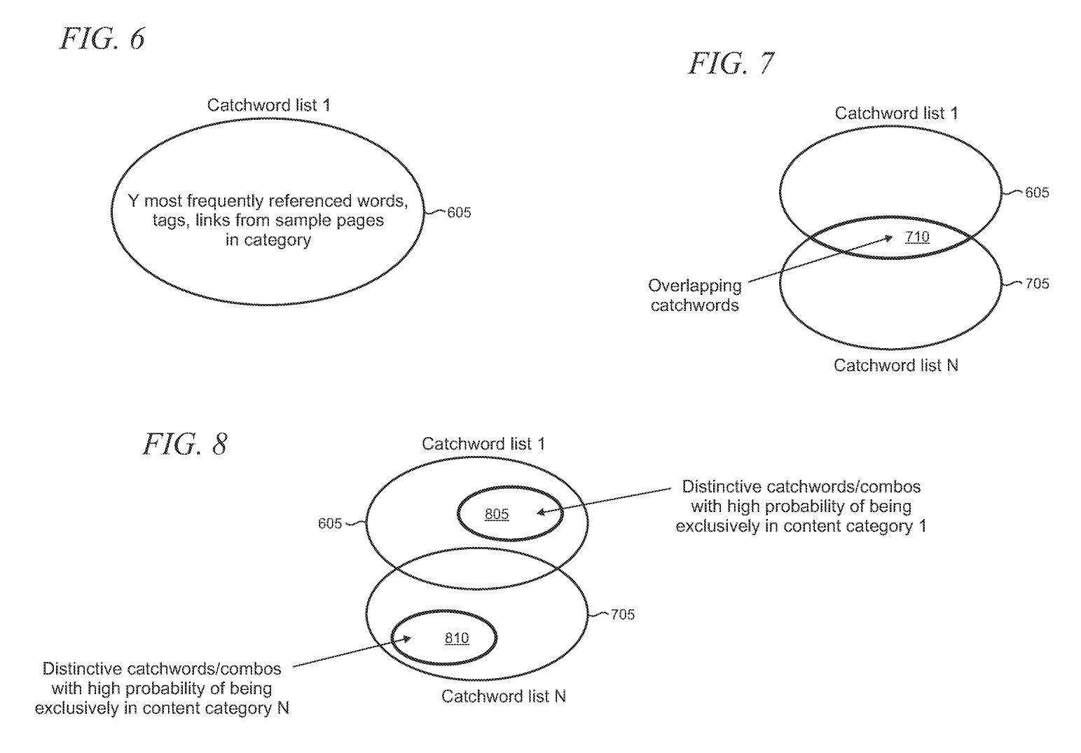

FIGS. 6-8 provide graphical representations of catchwords and distinctive catchwords/combinations to highlight the definitions of those terms as used herein. FIG. 6 shows an exemplary catchword list 1 that includes Y most frequently referenced catchwords from the sample pages 505 (FIG. 5) in a given content category. The boundary of the extent of catchword list 1 is indicated by reference numeral 605. Another catchword list N is shown in FIG. 7 with a boundary shown by reference numeral 705. As indicated by reference numeral 710, there is an overlap of catchwords between the two lists. Such overlap can be anticipated given that catchwords are defined to include the most frequently occurring words on the sample pages. FIG. 8 shows the results of the data mining including a first unique set of distinctive catchwords/combinations 805 that have a high probability of being exclusively in content category 1 and an N^{th} unique set of distinctive catchwords/combinations 810 that have a high probability of being exclusively in content category N.

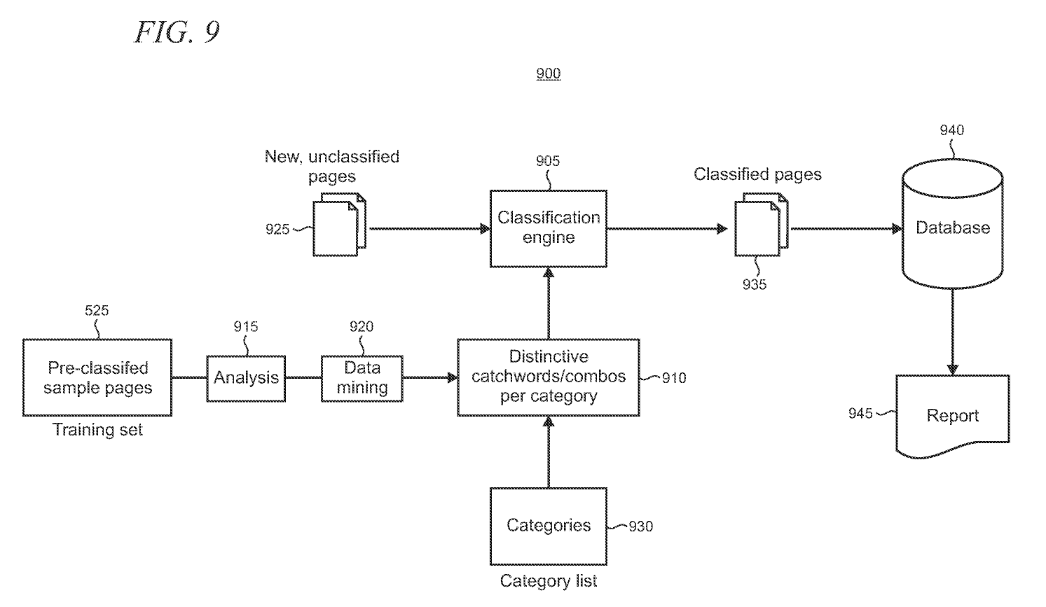

FIG. 9 shows application of an illustrative classifier 900 including a classification engine 905 that uses the distinctive catchwords/combinations 910 resulting from analysis 915 of the training set 525 and data mining 920 to classify new pages 925 using the pre-defined content categories 930. The classification engine 905 and other elements of the classifier 900 may be disposed in some cases in the NIS 135 (FIG. 1) using all or portions of the functionality provided by the DPI machine 405 (FIG. 4) or implemented as standalone functionality in some instances. The classified pages 935 may be written to a database 940 or transmitted to a remote destination in some cases. Various reports, such as a report on web page content classification 945, may be generated from the database 940.

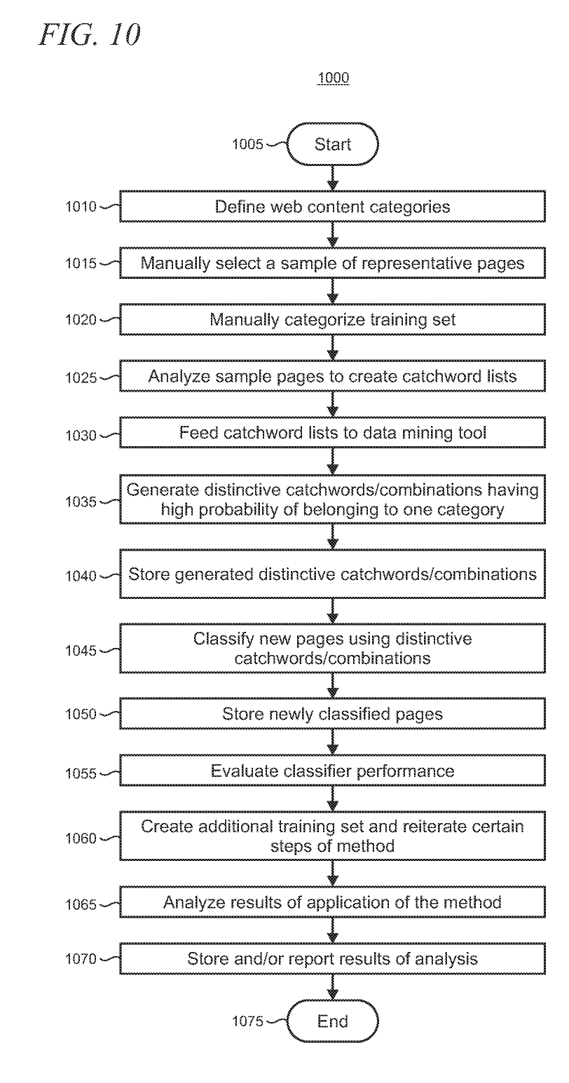

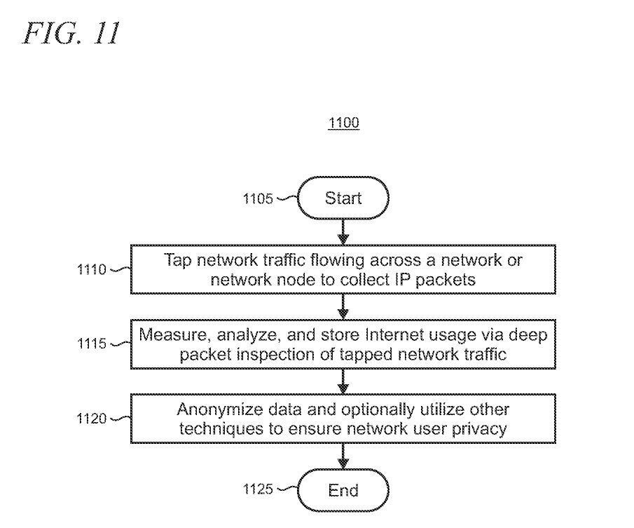

FIG. 10 shows a flowchart of an illustrative method 1000 for automated classification of web pages and/or domains. The method 1000 may be implemented, for example, using the elements shown in FIGS. 5 and 9 and described in the accompanying text. The method begins at block 1005. Content categories for web pages are defined at block 1010 where the number and types of categories may vary by application. At block 1015, a representative sample of the most visited pages in each of the content categories is manually selected. The visitation frequency may be derived, for example, from analysis of the Internet usage measurements 325 (FIG. 3). Alternatively, externally generated data (i.e., data from a source outside the NIS 135 shown in FIG. 1 and described in the accompanying text) can be used to determine the most visited sites for each of the content categories.

In those applications where the NIS 135 is utilized to determine the visitation frequency, the method 1100 shown in FIG. 11 may be employed which starts at block 1105. At block 1110, traffic flowing across a network or network node is tapped to collect IP packets. At block 1115, Internet usage is measured, analyzed, and stored for the network users typically using deep packet inspection where exemplary metrics for the measurement and analysis are shown in FIG. 3 by reference numeral 330. The frequency of page visitations may typically be derived from the deep packet inspection of the tapped traffic. At block 1120, data utilized by the NIS 135, or portions thereof may be anonymized to remove identifying information from the data, for example, to ensure that privacy of the network access device users is maintained. It is emphasized that while the method step in block 1120 is shown as occurring after block 1115, the anonymization described here may generally be included as part of the step shown in block 1115 or alternatively applied to the captured data at any point in the method 1100. Other techniques may also be optionally utilized in some implementations to further enhance privacy, including for example, providing notification to the users 105 (FIG. 1) that certain anonymized data may be collected and utilized to enhance network performance or improve the variety of features and services that may be offered to users in the future, and providing an opportunity to opt out (or opt in) to participation in the collection.

End-user privacy may be preserved by irreversibly anonymizing all Personally Identifiable Information (PII) present in the extracted data. This anonymization takes into account both direct and indirect exposure of user privacy by applying a multitude of methods. Direct PII refers to names, numbers, and addresses that could as such identify an individual end-user, while indirect PII refers to the use of rare devices, applications, or content that could potentially identify an individual end-user.

Confidentiality of communications is fully respected and maintained in the present arrangement, as no private communications content is collected. More specifically, the majority of data is extracted from packet headers, and data from packet payloads is extracted only on specific cases where part of the payload in question is known to be public content, such as in the case of traffic sent in known format by known advertising servers. The data is collected by default on a census basis, but mechanisms for filtering in the data of opt-in end-users and filtering out the data of opt-out users are also supported. Method 1100 ends at block 1125.

Returning to FIG. 10, each of the sample pages is manually classified, at block 1020, into the appropriate pre-defined category according to the type of content that is included in each page to create a training set. In some cases, the domains that support the pages may themselves be categorized instead of pages, or be utilized as a supplement to the categorized pages. At block 1025, the training set is analyzed to create a list of catchwords for each of the pre-defined categories. The analysis is typically performed in an automated manner by identifying the Y most frequently referenced catchwords from the sample pages that are populated in each category. The catchword lists are fed to the data mining tool at block 1030, and the data mining tool generates a set of distinctive catchwords and/or distinctive combinations of catchwords for each of the pre-defined content categories at block 1035. Catchwords and/or catchword combinations are considered distinctive if their probability of being exclusively associated with a single content category exceeds a predetermined threshold. At block 1040, the generated distinctive catchwords/combinations are stored in a database.

At block 1045, new pages (and/or domains) are classified into the pre-defined categories by a classification engine by checking if content included on the new pages matches with any of the distinctive catchwords/combinations in each of the pre-defined content categories. The new pages can be classified into one or more than one category depending on the value of the probability threshold that is utilized by the data mining tool when creating the distinctive catchwords/combinations. Using a higher probability threshold will typically result in fewer pages being classified into multiple categories while a lower probability threshold will result in more pages being classified into multiple categories. The newly classified pages may be stored in a database at block 1050.

The performance of the classifier may be evaluated at block 1055. For example, a sample of classified pages may be selected and subjected to catchword analysis as a check. In some instances, one or more additional training sets of manually categorized sample pages may be created and utilized as inputs to the method and the steps of catchword and distinctive catchwords/combinations generation and new page classification iterated as shown at block 1060. Additional training sets could be used, for example, to retrain the classifier, enhance or improve classification performance (e.g., in view of standard evaluation measures such as true positive, false positive, etc.), or implement different content categories (e.g., different number of categories, different category labels, etc.). The results of application of the method 1000 described above may be analyzed at block 1065. The results of the analysis may be stored or reported to remote locations at block 1070. The method ends at block 1075.

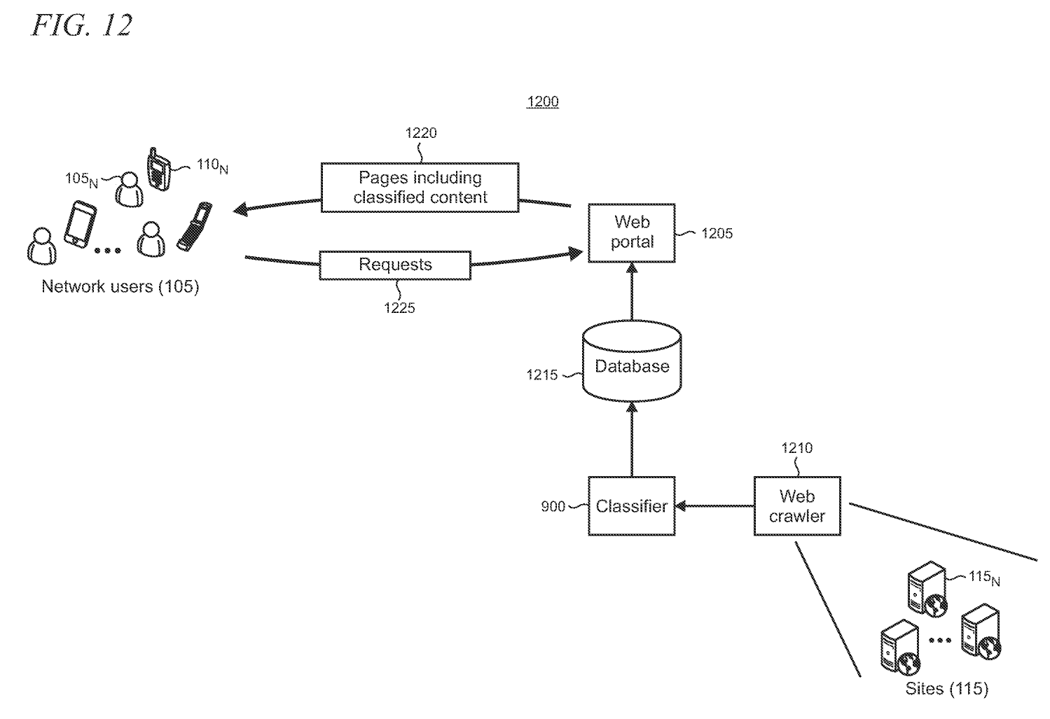

FIG. 12 shows an illustrative application of the present automated classification in a web portal environment 1200. Here, network users 105 interact with a web portal 1205 that typically functions as a point of access to the World Wide Web and Internet (not shown) by presenting a range of information, links, and services in a cohesive and generally user-personalized manner. For example, a web portal may include a search facility while also providing services such as e-mail, instant messaging, social networking, news, entertainment, weather, stock prices, and the like. A web crawler 1210 retrieves pages from the websites 115 which are passed to the classifier 900 which classifies the pages into pre-determined categories in an automated manner using the classification method described above.

The classified pages are stored in a database 1215 by category and are accessible by the web portal 1205. The web portal 1205 can utilize the pages which are classified by category when composing a web portal page 1220 for a user 105. For example, the classification may enable an additional layer of filtering to be applied when presenting links of potential interest to the user. The users 105 may also make requests 1225 to the web portal 1205 that indicate content categories of particular interest that can be used to personalize web portal pages to specific users. In addition, in cases where the web portal 1205 is configured to provide search functionality, search results that are classified by category may be returned to the users 105 in response to requests 1225.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for automated classification of web pages or domains, the method comprising the steps of:
receiving a training set, the training set comprising pages manually classified into pre-defined content categories according to page content, the pages being served by Internet-based servers accessible from a communications network;
analyzing pages in the training set to generate catchword lists by category, each catchword list having Y most referenced words, tags, or links on the pages classified in respective pre-defined content categories;
generating distinctive catchwords or distinctive catchword combinations for each of the pre-defined content categories using the catchword lists, a catchword or catchword combination being distinctive when their probability of appearing in pages or domains contained in a single pre-defined content category exceeds a predetermined probability threshold; and
classifying the web pages or domains by matching words in the web pages or domains to the generated distinctive catchwords or distinctive catchword combinations.

2. The method of claim 1 in which pages in the training set comprise pages that communication network users visit more frequently than pages that are not included in the training set.

3. The method of claim 2 in which page visitation frequency is determined using deep packet inspection of a tapped stream of IP traffic flowing between network access equipment utilized by the users and the Internet-based servers.

4. The method of claim 3 in which the tapped stream of IP packets is subjected to anonymization to maintain privacy of the users.

5. The method of claim 1 in which the generating is implemented using a data mining tool.

6. The method of claim 5 in which the data mining tool executes an algorithm including one of regression, classification, clustering, neural networks, or k-nearest neighbors.

7. The method of claim 1 in which the steps of receiving, analyzing, generating, and classifying are performed in a substantially automated manner using computer-readable software code executing on a computing platform.

8. The method of claim 1 further including the steps of receiving one or more additional training sets and iterating the steps of analyzing, generating, and classifying.

9. The method of claim 1 further including a step of storing results of application of the method to a database.

10. The method of claim 9 further including a step of generating a report using the stored results.

11. A method for classifying web pages accessible by users of a communications network, the method comprising the steps of:
defining a plurality of content categories;
selecting a representative sample of web pages that are frequently visited by the users;
populating the sample pages into respective content categories according to content contained in the sample pages;
creating a list of catchwords for each content category using the classified sample pages, each catchword list comprising words, tags, or links that are referenced at a frequency which meets a reference frequency threshold;
applying data mining to the lists of catchwords to generate distinctive catchwords for each content category, the catchwords being distinctive if meeting a target probability of appearing solely in the pages populated into that content category; and
classifying new pages into ones of the content categories by matching catchwords on the new pages to the distinctive catchwords.

12. The method of claim 11 in which the network is a mobile communications network.

13. The method of claim 12 in which page visitation frequency is determined using deep packet inspection of a tapped stream of IP traffic flowing between mobile equipment utilized by the users and Internet-based servers.

14. The method of claim 12 in which the mobile equipment comprises one of mobile phone, e-mail appliance, smart phone, non-smart phone, M2M equipment, PDA, PC, ultra-mobile PC, tablet device, tablet PC, handheld game device, digital media player, digital camera, GPS navigation device, pager, wireless data card, wireless dongle, wireless modem, or device which combines one or more features thereof.

15. The method of claim 11 further including applying the steps of selecting, populating, creating, applying, and classifying to one or more domains.

16. A method for providing an online experience to users of a network including presentation of pages classified into content categories, the method comprising the steps of:
determining frequency of access to pages available to the users by measuring Internet usage over the network;
selecting pages by content for inclusion in the content categories in view of the determined frequency of access to create a training set;
analyzing the training set to create a list of catchwords for each content category;
applying data mining to the lists of catchwords to generate distinctive catchwords for each content category, the catchwords being distinctive if meeting a target probability of appearing solely in the pages populated into that content category:
classifying new pages into ones of the content categories by matching catchwords on the new pages to the distinctive catchwords; and
presenting information associated with the classified new pages by category to the user in the online experience.

17. The method of claim 16 in which the measuring is performed during web-browsing sessions by tapping IP traffic traversing a node of a mobile communications network and further including a step of performing deep packet inspection on the tapped IP traffic.

18. The method of claim 16 in which the online experience is provided by a web portal.

19. The method of claim 16 further including a step of including links to the classified new pages by category to the user in the online experience.

20. The method of claim 16 in which the steps of analyzing, applying, classifying, and presenting are performed in a substantially automated manner.
